(19) United States
(12) Patent Application Publication
(10) Pub. No.: US 2026/0125278 A1
(43) Pub. Date: May 7, 2026

(54) METHOD FOR RECOVERING NICKEL HYDROXIDE AND NICKEL SULFATE FROM NICKEL-CONTAINING MATERIALS

(71) Applicant: Korea Institute Of Geoscience And Mineral Resources, Daejeon (KR)

(72) Inventors: Tae-Gong RYU, Daejeon (KR); Jun-Ho SHIN, Daejeon (KR); Jae-Min JEONG, Daejeon (KR)

(73) Assignee: Korea Institute Of Geoscience And Mineral Resources, Daejeon (KR)

(21) Appl. No.: 19/116,540

(22) PCT Filed: Sep. 27, 2023
(86) PCT No.: PCT/KR2023/015011

§ 371 Date: Mar. 28, 2025

(30) Foreign Application Priority Data
Oct. 6, 2022 (KR) 10-2022-0127986

(51) Int. Cl. C01G 53/10; C01G 53/05; C22B 1/24; C22B 3/22; C22B 7/00

(52) U.S. Cl. CPC C01G 53/10; C01G 53/05; C22B 1/24; C22B 3/22; C22B 7/007

(57) ABSTRACT

The present invention provides a method for recovering nickel hydroxide and nickel sulfate from nickel-containing materials, wherein the nickel-containing materials are crushed and pulverized and then leached with sulfuric acid, leached residue separation and filtrate separation are performed and then the pH is adjusted to recover nickel hydroxide, and the recovered nickel hydroxide is further subjected to a sulfation reaction to recover nickel sulfate.

### TECHNICAL FIELD

The present disclosure relates to a method for recovering nickel hydroxide and nickel sulfate from nickel-containing materials, wherein the nickel-containing materials are crushed and pulverized and then leached with sulfuric acid, leached residue separation and filtrate separation are performed and then the pH is adjusted to recover nickel hydroxide, and the recovered nickel hydroxide is further subjected to a sulfation reaction to recover nickel sulfate.

### BACKGROUND ART

Nickel is widely used across various industries, and its consumption is gradually increasing, particularly due to industrial advancements and the expansion of markets for electric vehicles (xEV), energy storage systems (ESS), and lithium-ion batteries.

As a result, domestic nickel consumption is on the rise, and among the top five imported minerals in the year of 2020 (nickel, palladium, platinum, silicon, and lithium), nickel showed the highest dependence on imports.

The domestic demand for nickel is met either by importing and refining foreign raw ores or by importing alloys and compounds in their entirety for industrial use. In particular, nickel hydroxide and nickel sulfate, which are in compound form, are primarily used as plating materials and cathode materials for secondary batteries.

Furthermore, with the explosive growth in demand for electric vehicles and energy storage systems (ESS), the nickel market has been expanding accordingly. In particular, the demand for high-nickel lithium-ion batteries is increasing due to the need for high current density and the unstable supply of cobalt raw materials. As a result, the demand for nickel compounds is expected to exceed 40,000 tons by the year of 2025.

Domestic nickel production from nickel ore is minimal, and the country is highly dependent on imports. Nickel ore is primarily imported from Southeast Asia (the Philippines, Indonesia, China, etc.), while processed nickel powder products are imported from Canada and the United Kingdom.

However, due to recent resource weaponization policies, export restrictions by resource-rich countries, and trade wars, the supply and price volatility of nickel resources have intensified, necessitating a stable supply chain.

Moreover, Nickel, which is mainly used in industries such as lithium-ion batteries, steel alloys, plating, semiconductors, and multilayer ceramic capacitor (MLCC), is also accompanied by the generation of nickel-containing materials during processing. However, as nickel has been designated as a hazardous chemical, there is an urgent need for proper disposal methods for nickel-based waste and the development of stable and environmentally friendly recovery technologies.

Currently, technologies for recovering and refining nickel from nickel-containing materials are limited to high-cost solvent extraction, electrowinning, or reprocessing into low-grade nickel raw materials for use in alloy and steel manufacturing. In particular, domestic technological development for recovery and refining through high-efficiency, low-cost hydrometallurgical processes remains insufficient.

Therefore, to address the heavy reliance on nickel imports and to secure a stable supply of raw materials, the importance of developing technologies that efficiently recover and recycle nickel from nickel-containing materials, including nickel ores, is increasingly being emphasized.

Therefore, through extensive research and dedicated efforts, the applicants of the present disclosure have developed a method for recovering nickel hydroxide and nickel sulfate from nickel-containing materials. In this method, the nickel-containing materials are crushed and pulverized, followed by sulfuric acid leaching. The leached residue and filtrate are then separated, and pH adjustment is performed to recover nickel hydroxide. The recovered nickel hydroxide is further subjected to a sulfation reaction to obtain nickel sulfate, thereby completing the present disclosure.

### DISCLOSURE

### Technical Problem

Accordingly, a purpose of the present disclosure is to a method for recovering nickel hydroxide by crushing and pulverizing nickel-containing materials, leaching them with sulfuric acid, separating the leached residue and filtrate, and then adjusting the pH.

In addition, another purpose of the present disclosure is to provide a method for recovering nickel sulfate by further subjecting the recovered nickel hydroxide to a sulfation reaction.

Furthermore, still another purpose of the present disclosure is to provide the nickel hydroxide recovered through a method for recovering nickel hydroxide wherein nickel-containing materials are crushed and pulverized, leached with sulfuric acid, the leached residue and filtrate are separated, and then the pH is adjusted.

Moreover, still another purpose of the present disclosure is to provide the nickel sulfate recovered through a method for recovering nickel sulfate wherein the recovered nickel hydroxide is further subjected to a sulfation reaction.

The challenges that the present disclosure is intended to solve are not limited to those mentioned above, and other challenges not mentioned will be apparent to those skilled in the art from the following description.

### Technical Solution

In order to achieve the purpose, an aspect of the present disclosure provides a method for recovering nickel hydroxide from nickel-containing material, comprising steps of:
(a-1) crushing and pulverizing the nickel-containing material;
(a-2) leaching the crushed and pulverized nickel-containing material with sulfuric acid to form a first sulfuric acid leachate containing a primary filtrate;
(a-3) separating a leached residue and the primary filtrate from the first sulfuric acid leachate;
(a-4) performing a primary pH adjustment on the first sulfuric acid leachate, from which the leached residue has been separated, to form a second sulfuric acid leachate containing a primary pH-adjusted impurity precipitate and a secondary filtrate;
(a-5) separating the primary pH-adjusted impurity precipitate and the secondary filtrate from the second sulfuric acid leachate;
(a-6) performing a secondary pH adjustment on the second sulfuric acid leachate, from which the impurity precipitate has been separated, to separate nickel hydroxide; and
(a-7) washing the separated nickel hydroxide to recover nickel hydroxide.

In some exemplary embodiments, in the step (a-1) of crushing and pulverizing the nickel-containing material,
the nickel-containing material may include nickel-containing sludge, nickel-containing slag, nickel-containing minerals, or waste ferronickel slag, which are generated during manufacturing of electrical/electronic devices and recycling process of waste electrical/electronic devices, and
a metallic component of the nickel-containing material may include at least one selected from a group consisting of Ni, Al, Fe, Mg, Si, Ba, Ca, P, Cu, Zn, Zr, B, Ba, Cr, Sr, and Mn.

In some exemplary embodiments, in the step (a-1) of crushing and pulverizing the nickel-containing material, the crushing and pulverizing process may comprise:
a primary crushing step using a jaw crusher or a cone crusher; and
a secondary pulverizing step using a rod mill, a pin mill, a ball mill, a tube mill, a pot mill, a roller mill, a turbo mill, or a tower mill.

Here, a particle size of a multilayer ceramic capacitor process sludge, which is crushed and pulverized, may range from 0.1 μm to 5 mm.

In some exemplary embodiments, in the step (a-2) of leaching the crushed and pulverized nickel-containing material with sulfuric acid to form a first sulfuric acid leachate containing a primary filtrate,
the sulfuric acid leaching may be performed under conditions where a solid-to-liquid ratio of the crushed and pulverized nickel-containing material (g) to sulfuric acid solution (L) ranges from 50 to 200,
a molar concentration of the sulfuric acid solution may range from 0.2 to 5 M, and
a leaching temperature may range from 10 to 90° C.

In some exemplary embodiments, in the step (a-3) of separating a leached residue and the primary filtrate from the first sulfuric acid leachate,
separation of impurity from the first sulfuric acid leachate may be performed by separating the leached residue that has not leached.

In some exemplary embodiments, in the step (a-4) of performing a primary pH adjustment on the first sulfuric acid leachate, from which the leached residue has been separated, to form a second sulfuric acid leachate containing a primary pH-adjusted impurity precipitate and a secondary filtrate,
a pH of the primary pH adjustment may range from 2 to 7.

In some exemplary embodiments, in the step (a-5) of separating the primary pH-adjusted impurity precipitate and the secondary filtrate from the second sulfuric acid leachate,
the separation of the impurity precipitate from the second sulfuric acid leachate may be performed by a pH titration method sequentially using metal hydroxide and metal fluoride,
the metal hydroxide may be at least one selected from a group consisting of NaOH, KOH, Mg(OH)₂, Ca(OH)₂, and Al(OH)₃, and
the metal fluoride may be at least one selected from a group consisting of sodium fluoride (NaF), ammonium fluoride (NH₄F), potassium fluoride (KF), ferrous fluoride (FeF₂), ferric fluoride (FeF₃), aluminum fluoride (AlF₃), and hydrofluoric acid (HF).

In some exemplary embodiments, in the step (a-5) of separating the primary pH-adjusted impurity precipitate and the secondary filtrate from the second sulfuric acid leachate,
the separation of the impurity precipitate from the second sulfuric acid leachate may be performed by a pH titration method sequentially using metal hydroxide and metal fluoride,
wherein conditions for the separation of the impurity precipitate may include:
a pH titration temperature ranging from 10 to 90° C.;
a molar ratio of nickel to metal hydroxide in the second sulfuric acid leachate ranging from 1:0.01 to 0.01:1; and
a molar ratio of nickel to metal fluoride in the second sulfuric acid leachate, after nickel and impurities in the second sulfuric acid leachate have been pH-titrated and separated as metal hydroxides, ranging from 1:0.02 to 0.02:1.

In some exemplary embodiments, in the step (a-6) of performing a secondary pH adjustment on the second sulfuric acid leachate, from which the impurity precipitate has been separated, to separate nickel hydroxide,
a pH of the secondary pH adjustment may range from 6 to 13.

In some exemplary embodiments, in the step (a-7) of washing the separated nickel hydroxide to recover nickel hydroxide,
the washing may be performed using deionized water to remove water-soluble impurity components contained in the nickel hydroxide.

In addition, another aspect of the present disclosure provides a method for recovering nickel sulfate from nickel-containing material, comprising steps of:
(a-1) crushing and pulverizing the nickel-containing material;
(a-2) leaching the crushed and pulverized nickel-containing material with sulfuric acid to form a first sulfuric acid leachate containing a primary filtrate;
(a-3) separating a leached residue and the primary filtrate from the first sulfuric acid leachate;
(a-4) performing a primary pH adjustment on the first sulfuric acid leachate, from which the leached residue has been separated, to form a second sulfuric acid leachate containing a primary pH-adjusted impurity precipitate and a secondary filtrate;
(a-5) separating the primary pH-adjusted impurity precipitate and the secondary filtrate from the second sulfuric acid leachate;
(a-6) performing a secondary pH adjustment on the second sulfuric acid leachate, from which the impurity precipitate has been separated, to separate nickel hydroxide;
(a-7) washing the separated nickel hydroxide to recover nickel hydroxide; and
(a-8) performing a sulfation reaction between the recovered nickel hydroxide and a sulfuric acid compound to recover nickel sulfate.

In some exemplary embodiments, in the step (a-8) of performing a sulfation reaction between the recovered nickel hydroxide and a sulfuric acid compound to recover nickel sulfate,
the sulfuric acid compound may be at least one selected from a group consisting of:
sulfuric acid (H₂SO₄), sulfurous acid (H₂SO₃), hyposulfurous acid (H₂SO₂), magnesium sulfate (MgSO₄), magnesium sulfite (MgSO₃), magnesium hyposulfite (MgSO₂), calcium sulfate (CaSO₄), calcium sulfite (CaSO₃), calcium hyposulfite (CaSO₂), ferrous sulfate (FeSO₄), ferrous sulfite (FeSO₃), ferrous hyposulfite (FeSO₂), ferric sulfate (Fe₂(SO₄)₃), ferric sulfite (Fe₂(SO₃)₃), ferric hyposulfite (Fe₂(SO₂)₃), ammonium sulfate ((NH₄)₂SO₄), aluminum sulfate (Al₂(SO₄)₃), aluminum sulfite (Al₂(SO₃)₃), and aluminum hyposulfite (Al₂(SO₂)₃).

In some exemplary embodiments, in the step (a-8) of performing a sulfation reaction between the recovered nickel hydroxide and a sulfuric acid compound to recover nickel sulfate,
the sulfation reaction may be performed under conditions characterized by:
a molar ratio of nickel hydroxide to the sulfuric acid compound, expressed as a molar ratio of SO₄/Ni, ranging from 0.5 to 5;
a reaction temperature ranging from 80° C. to 800° C.; and
a reaction time ranging from 0.5 hour to 36 hours.

In addition, still another aspect of the present disclosure provides a nickel hydroxide recovered by the method for recovering nickel hydroxide from nickel-containing material.

In some exemplary embodiments, a purity of the nickel hydroxide recovered by the method for recovering nickel hydroxide from nickel-containing material may range from 95 to 99.995 wt %.

In some exemplary embodiments, a recovery rate of the nickel hydroxide recovered by the method for recovering nickel hydroxide from nickel-containing material may range from 80 to 99.9 wt %

In addition, still another aspect of the present disclosure provides a nickel sulfate recovered from the method for recovering nickel sulfate from nickel-containing material.

In some exemplary embodiments, a purity of the nickel sulfate recovered from the method for recovering nickel sulfate from nickel-containing material may range from 95 to 99.995 wt %.

In some exemplary embodiments, a recovery rate of the nickel sulfate recovered from the method for recovering nickel sulfate from nickel-containing material may range from 95 to 99.995 wt %.

### Advantageous Effects

According to the present disclosure, a method is provided for recovering nickel hydroxide by crushing and pulverizing a nickel-containing material, leaching it with sulfuric acid, separating the leached residue and filtrate, and then adjusting the pH. This method reduces waste disposal costs as well as the cost of nickel hydroxide recovery.

Furthermore, the present disclosure provides a method for recovering nickel sulfate by further subjecting the recovered nickel hydroxide to a sulfation reaction, thereby significantly reducing environmental burden and improving process efficiency.

In addition, the present disclosure provides nickel hydroxide recovered by the method of crushing and pulverizing a nickel-containing material, leaching it with sulfuric acid, separating the leached residue and filtrate, and then adjusting the pH, ensuring high purity and high recovery rates of the recovered nickel hydroxide.

Moreover, the present disclosure provides nickel sulfate recovered by the method of further subjecting the recovered nickel hydroxide to a sulfation reaction, ensuring high purity and high recovery rates of the recovered nickel sulfate.

The effects of the present disclosure are not limited to the aforementioned effects and should be understood to include all effects that can be inferred from the configurations of the present disclosure described in the detailed description or the claims.

### DESCRIPTION OF DRAWINGS

FIG. 1 is a process flow diagram of the method for recovering nickel hydroxide and nickel sulfate from nickel-containing material according to an exemplary embodiment of the present disclosure.

FIG. 2 is a photograph of MLCC process sludge and its pulverized powder according to an exemplary embodiment of the present disclosure.

FIGS. 3a to 3d are graphs showing the distribution of leaching concentrations for different components based on sulfuric acid concentration and leaching temperature according to an exemplary embodiment of the present disclosure.

FIGS. 4a to 4c are graphs showing (a) MLCC leaching temperature, (b) sulfuric acid concentration (mol/L) in the leaching solution, and (c) nickel leaching rate based on the solid (g)/liquid (L) ratio according to an exemplary embodiment of the present disclosure.

FIG. 5 is a graph showing the distribution of metal ion concentrations in the leaching solution at different pH levels upon the addition of (a) NaOH and (b) Ca(OH)₂ according to an exemplary embodiment of the present disclosure.

FIG. 6 is a graph showing the distribution of residual ions in the MLCC process sludge leaching solution after applying NaOH and Ca(OH)₂ according to an exemplary embodiment of the present disclosure.

FIG. 7 is a graph showing the distribution of residual ions in the filtrate of MLCC process sludge leachate after applying fluorides according to an exemplary embodiment of the present disclosure.

FIG. 8 is a graph showing the distribution of nickel content in the filtrate and the recovery rate of nickel hydroxide based on solution pH after applying NaOH according to an exemplary embodiment of the present disclosure.

FIGS. 9a to 9c are X-ray distraction (XRD) patterns of nickel sulfate products obtained from the sulfation roasting reaction of nickel hydroxide at different roasting temperatures and SO₄/Ni molar ratios according to an exemplary embodiment of the present disclosure.

FIG. 10 shows X-ray distraction (XRD) patterns of nickel sulfate products obtained through the sulfuric acid leaching and crystallization of nickel hydroxide according to an exemplary embodiment of the present disclosure.

### MODE FOR INVENTION

Hereinafter, exemplary embodiments of the present disclosure will be described in detail with reference to related drawings.

The advantages and features of the present disclosure, and methods of accomplishing those advantages and features, will become apparent upon reference to the exemplary embodiments described in detail with reference to the accompanying drawings.

However, the present disclosure is not limited by the exemplary embodiments disclosed herein, but will be embodied in many and various forms. Therefore, those exemplary embodiments are provided merely to make the present disclosure complete and to give a complete picture of the scope of the present disclosure to one of ordinary skill in the art to which the present disclosure belongs, and the present disclosure shall be defined by the scope of the claims.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in detail.

Method for Recovering Nickel Hydroxide from Nickel-Containing Material

The present disclosure provides a method for recovering nickel hydroxide and nickel sulfate from nickel-containing materials, wherein the nickel-containing materials are crushed and pulverized and then leached with sulfuric acid, leached residue separation and filtrate separation are performed and then the pH is adjusted to recover nickel hydroxide.

According to an exemplary embodiment of the present disclosure, the method for recovering nickel hydroxide from nickel-containing material comprises steps of:
(a-1) crushing and pulverizing the nickel-containing material;
(a-2) leaching the crushed and pulverized nickel-containing material with sulfuric acid to form a first sulfuric acid leachate containing a primary filtrate;
(a-3) separating a leached residue and the primary filtrate from the first sulfuric acid leachate;
(a-4) performing a primary pH adjustment on the first sulfuric acid leachate, from which the leached residue has been separated, to form a second sulfuric acid leachate containing a primary pH-adjusted impurity precipitate and a secondary filtrate;
(a-5) separating the primary pH-adjusted impurity precipitate and the secondary filtrate from the second sulfuric acid leachate;
(a-6) performing a secondary pH adjustment on the second sulfuric acid leachate, from which the impurity precipitate has been separated, to separate nickel hydroxide; and
(a-7) washing the separated nickel hydroxide to recover nickel hydroxide.

The present disclosure provides a method for recovering nickel hydroxide by crushing and pulverizing a nickel-containing material, leaching it with sulfuric acid, separating the leached residue and filtrate, and then adjusting the pH. This method reduces waste disposal costs as well as the cost of nickel hydroxide recovery.

Nickel is widely used across various industries, and its consumption is gradually increasing, particularly due to industrial advancements and the expansion of markets for electric vehicles (xEV), energy storage systems (ESS), and lithium-ion batteries.

As a result, domestic nickel consumption is on the rise, and among the top five imported minerals in the year of 2020 (nickel, palladium, platinum, silicon, and lithium), nickel showed the highest dependence on imports.

The domestic demand for nickel is met either by importing and refining foreign raw ores or by importing alloys and compounds in their entirety for industrial use. In particular, nickel hydroxide and nickel sulfate, which are in compound form, are primarily used as plating materials and cathode materials for secondary batteries.

Furthermore, with the explosive growth in demand for electric vehicles and energy storage systems (ESS), the nickel market has been expanding accordingly. In particular, the demand for high-nickel lithium-ion batteries is increasing due to the need for high current density and the unstable supply of cobalt raw materials. As a result, the demand for nickel compounds is expected to exceed 40,000 tons by the year of 2025.

Domestic nickel production from nickel ore is minimal, and the country is highly dependent on imports. Nickel ore is primarily imported from Southeast Asia (the Philippines, Indonesia, China, etc.), while processed nickel powder products are imported from Canada and the United Kingdom.

However, due to recent resource weaponization policies, export restrictions by resource-rich countries, and trade wars, the supply and price volatility of nickel resources have intensified, necessitating a stable supply chain.

Moreover, Nickel, which is mainly used in industries such as lithium-ion batteries, steel alloys, plating, semiconductors, and multilayer ceramic capacitor (MLCC), is also accompanied by the generation of nickel-containing materials during processing. However, as nickel has been designated as a hazardous chemical, there is an urgent need for proper disposal methods for nickel-based waste and the development of stable and environmentally friendly recovery technologies.

Currently, technologies for recovering and refining nickel from nickel-containing materials are limited to high-cost solvent extraction, electrowinning, or reprocessing into low-grade nickel raw materials for use in alloy and steel manufacturing. In particular, domestic technological development for recovery and refining through high-efficiency, low-cost hydrometallurgical processes remains insufficient.

Therefore, to address the heavy reliance on nickel imports and to secure a stable supply of raw materials, the importance of developing technologies that efficiently recover and recycle nickel from nickel-containing materials, including nickel ores, is increasingly being emphasized.

Therefore, through extensive research and dedicated efforts, the applicants of the present disclosure have developed a method for recovering nickel hydroxide and nickel sulfate from nickel-containing materials. In this method, the nickel-containing materials are crushed and pulverized, followed by sulfuric acid leaching. The leached residue and filtrate are then separated, and pH adjustment is performed to recover nickel hydroxide. The recovered nickel hydroxide is further subjected to a sulfation reaction to obtain nickel sulfate, thereby completing the present disclosure.

Here, in the step (a-1) of crushing and pulverizing the nickel-containing material, the nickel-containing material may include nickel-containing sludge, nickel-containing slag, nickel-containing minerals, or waste ferronickel slag, which are generated during manufacturing of electrical/electronic devices and recycling process of waste electrical/electronic devices, and a metallic component of the nickel-containing material may include at least one selected from a group consisting of Ni, Al, Fe, Mg, Si, Ba, Ca, P, Cu, Zn, Zr, B, Ba, Cr, Sr, and Mn.

In addition, in the step (a-1) of crushing and pulverizing the nickel-containing material, the crushing and pulverizing process may comprise:
a primary crushing step using a jaw crusher or a cone crusher; and
a secondary pulverizing step using a rod mill, a pin mill, a ball mill, a tube mill, a pot mill, a roller mill, a turbo mill, or a tower mill.

Here, a particle size of a multilayer ceramic capacitor process sludge, which is crushed and pulverized, may range from 0.1 μm to 5 mm.

Here, when the particle size of the crushed and pulverized nickel-containing material deviates from the specified range, the acid leaching efficiency of the crushed and pulverized nickel-containing material may decrease.

In this case, the particle size of the crushed and pulverized nickel-containing material may be preferably in the range of 0.12 μm to 4.98 mm, and more preferably in the range of 0.15 μm to 4.95 mm.

In addition, in the step (a-2) of leaching the crushed and pulverized nickel-containing material with sulfuric acid to form a first sulfuric acid leachate containing a primary filtrate,
the sulfuric acid leaching may be performed under conditions where a solid-to-liquid ratio of the crushed and pulverized nickel-containing material (g) to sulfuric acid solution (L) ranges from 50 to 200,
a molar concentration of the sulfuric acid solution may range from 0.2 to 5 M, and
a leaching temperature may range from 10 to 90° C.

Here, when the solid-to-liquid ratio of the crushed and pulverized nickel-containing material (g) to the sulfuric acid solution (L) deviates from the specified range, the acid leaching efficiency of the crushed and pulverized nickel-containing material may decrease, or the concentration of nickel contained in the recovered leachate may be reduced.

In this case, the solid-to-liquid ratio of the crushed and pulverized nickel-containing material (g) to the sulfuric acid solution (L) may be preferably in the range of 55 to 195, and more preferably in the range of 60 to 190.

When the molar concentration of the sulfuric acid solution deviates from the specified range, the acid leaching efficiency of the crushed and pulverized nickel-containing material may decrease.

In this case, the molar concentration of the sulfuric acid solution may be preferably in the range of 0.25 to 4.98 M, and more preferably in the range of 0.3 to 4.95 M.

Further, when the leaching temperature deviates from the specified range, the acid leaching efficiency of the crushed and pulverized nickel-containing material may decrease.

In this case, the leaching temperature may be preferably in the range of 12 to 88° C., and more preferably in the range of 15 to 85° C.

Here, the concentration of the nickel component contained in the first sulfuric acid leachate may be 10,000 ppm or higher.

In addition, in the step (a-3) of separating a leached residue and the primary filtrate from the first sulfuric acid leachate, separation of impurity from the first sulfuric acid leachate may be performed by separating the leached residue that has not leached.

In other words, the impurity separation from the sulfuric acid leachate may be performed by separating the leached residue that has not been dissolved.

Further, in the step (a-4) of performing a primary pH adjustment on the first sulfuric acid leachate, from which the leached residue has been separated, to form a second sulfuric acid leachate containing a primary pH-adjusted impurity precipitate and a secondary filtrate, a pH of the primary pH adjustment may range from 2 to 7.

Here, when the primary pH adjustment deviates from the specified range, the nickel recovery rate may decrease, and the impurity separation efficiency may also be reduced.

In this case, the range of the primary pH adjustment may be preferably from 2.2 to 6.9, and more preferably from 2.3 to 6.8.

In addition, in the step (a-5) of separating the primary pH-adjusted impurity precipitate and the secondary filtrate from the second sulfuric acid leachate,
the separation of the impurity precipitate from the second sulfuric acid leachate may be performed by a pH titration method sequentially using metal hydroxide and metal fluoride,
the metal hydroxide may be at least one selected from a group consisting of NaOH, KOH, Mg(OH)₂, Ca(OH)₂, and Al(OH)₃, and
the metal fluoride may be at least one selected from a group consisting of sodium fluoride (NaF), ammonium fluoride (NH₄F), potassium fluoride (KF), ferrous fluoride (FeF₂), ferric fluoride (FeF₃), aluminum fluoride (AlF₃), and hydrofluoric acid (HF).

Here, the pH titration separation method may involve reacting the second sulfuric acid leachate with a metal hydroxide to separate impurity components combined with metal hydroxides and hydroxides, followed by reacting the second sulfuric acid leachate with a metal fluoride to further separate impurities.

In this case, the impurities may include Al, Fe, Mg, Si, Ba, Ca, P, Cu, Zn, Zr, B, Ba, Cr, Sr, or Mn, excluding nickel from the metallic components of the nickel-containing material.

In addition, in the step (a-5) of separating the primary pH-adjusted impurity precipitate and the secondary filtrate from the second sulfuric acid leachate,
the separation of the impurity precipitate from the second sulfuric acid leachate may be performed by a pH titration method sequentially using metal hydroxide and metal fluoride,
wherein conditions for the separation of the impurity precipitate may include:
a pH titration temperature ranging from 10 to 90° C.;
a molar ratio of nickel to metal hydroxide in the second sulfuric acid leachate ranging from 1:0.01 to 0.01:1; and
a molar ratio of nickel to metal fluoride in the second sulfuric acid leachate, after nickel and impurities in the second sulfuric acid leachate have been pH-titrated and separated as metal hydroxides, ranging from 1:0.02 to 0.02:1.

Here, when the pH titration temperature deviates from the specified range, the nickel recovery rate may decrease, or the impurity precipitate separation efficiency may be reduced.

In this case, the pH titration temperature may be preferably in the range of 12 to 88° C., and more preferably in the range of 15 to 85° C.

In addition, when the molar ratio of nickel to metal hydroxide in the second sulfuric acid leachate deviates from the specified range, the nickel recovery rate may decrease, or the impurity precipitate separation efficiency may be reduced.

In this case, the molar ratio of nickel to metal hydroxide in the second sulfuric acid leachate may be preferably in the range of 1:0.02 to 0.02:1, and more preferably in the range of 1:0.03 to 0.03:1.

Furthermore, when the molar ratio of nickel to metal fluoride in the second sulfuric acid leachate, after the pH titration and separation of nickel and impurities as metal hydroxides, deviates from the specified range, the impurity precipitate separation efficiency may decrease.

In this case, the molar ratio of nickel to metal fluoride in the second sulfuric acid leachate, after the pH titration and separation of nickel and impurities as metal hydroxides, is preferably in the range of 1:0.025 to 0.025:1, and more preferably in the range of 1:0.03 to 0.03:1.

In addition, in the step (a-6) of performing a secondary pH adjustment on the second sulfuric acid leachate, from which the impurity precipitate has been separated, to separate nickel hydroxide,
a pH of the secondary pH adjustment may range from 6 to 13.

Here, when the pH of the secondary pH adjustment deviates from the specified range, the nickel recovery rate may decrease, or the impurity separation efficiency may be reduced.

In this case, the range of the pH of the secondary pH adjustment may be preferably from 6.2 to 12.9, and more preferably from 6.3 to 12.8.

Further, in the step (a-7) of washing the separated nickel hydroxide to recover nickel hydroxide,
the washing may be performed using deionized water to remove water-soluble impurity components contained in the nickel hydroxide.

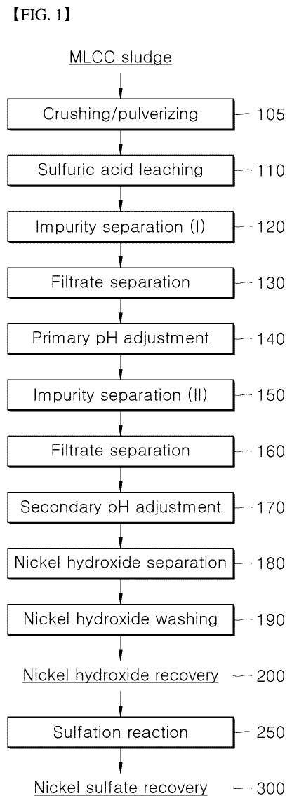

FIG. 1 is a process flow diagram of the method for recovering nickel hydroxide and nickel sulfate from nickel-containing material according to an exemplary embodiment of the present disclosure.

Referring to FIG. 1, the multilayer ceramic capacitor (MLCC) process sludge may be crushed and pulverized (105).

Then, the crushed and pulverized MLCC process sludge may undergo sulfuric acid leaching to form a first sulfuric acid leachate containing a primary filtrate (110).

Next, the leached residue and the primary filtrate may be separated from the first sulfuric acid leachate (130).

Afterwards, a primary pH adjustment may be performed on the first sulfuric acid leachate, from which the leached residue has been separated, to form a second sulfuric acid leachate containing a primary pH-adjusted impurity precipitate and a secondary filtrate.

Then, the primary pH-adjusted impurity precipitate and the secondary filtrate may be separated from the second sulfuric acid leachate (160).

Subsequently, a secondary pH adjustment may be performed on the second sulfuric acid leachate, from which the impurity precipitate has been separated, to separate nickel hydroxide (180).

Then, the separated nickel hydroxide may be washed (190) to recover the nickel hydroxide (200).

Method for Recovering Nickel Sulfate from Nickel-Containing Material

The present disclosure provides a method for recovering nickel sulfate from nickel-containing material by further performing a sulfation reaction on the recovered nickel hydroxide.

According to an exemplary embodiment of the present disclosure, the method for recovering nickel sulfate from nickel-containing material comprises steps of:
(a-1) crushing and pulverizing the nickel-containing material;
(a-2) leaching the crushed and pulverized nickel-containing material with sulfuric acid to form a first sulfuric acid leachate containing a primary filtrate;
(a-3) separating a leached residue and the primary filtrate from the first sulfuric acid leachate;
(a-4) performing a primary pH adjustment on the first sulfuric acid leachate, from which the leached residue has been separated, to form a second sulfuric acid leachate containing a primary pH-adjusted impurity precipitate and a secondary filtrate;
(a-5) separating the primary pH-adjusted impurity precipitate and the secondary filtrate from the second sulfuric acid leachate;
(a-6) performing a secondary pH adjustment on the second sulfuric acid leachate, from which the impurity precipitate has been separated, to separate nickel hydroxide;
(a-7) washing the separated nickel hydroxide to recover nickel hydroxide; and
(a-8) performing a sulfation reaction between the recovered nickel hydroxide and a sulfuric acid compound to recover nickel sulfate.

The present disclosure provides a method for recovering nickel sulfate by further subjecting the recovered nickel hydroxide to a sulfation reaction, thereby significantly reducing environmental burden and improving process efficiency.

Here, the method for recovering nickel sulfate from a nickel-containing material may include performing a sulfation reaction between the recovered nickel hydroxide and a sulfur-containing compound to recover nickel sulfate.

In this case, the sulfation reaction may include sulfation roasting or sulfuric acid leaching.

In addition, in the step (a-8) of performing a sulfation reaction between the recovered nickel hydroxide and a sulfuric acid compound to recover nickel sulfate,
the sulfuric acid compound may be at least one selected from a group consisting of:
sulfuric acid (H₂SO₄), sulfurous acid (H₂SO₃), hyposulfurous acid (H₂SO₂), magnesium sulfate (MgSO₄), magnesium sulfite (MgSO₃), magnesium hyposulfite (MgSO₂), calcium sulfate (CaSO₄), calcium sulfite (CaSO₃), calcium hyposulfite (CaSO₂), ferrous sulfate (FeSO₄), ferrous sulfite (FeSO₃), ferrous hyposulfite (FeSO₂), ferric sulfate (Fe₂(SO₄)₃), ferric sulfite (Fe₂(SO₃)₃), ferric hyposulfite (Fe₂(SO₂)₃), ammonium sulfate ((NH₄)₂SO₄), aluminum sulfate (Al₂(SO₄)₃), aluminum sulfite (Al₂(SO₃)₃), and aluminum hyposulfite (Al₂(SO₂)₃).

Further, in the step (a-8) of performing a sulfation reaction between the recovered nickel hydroxide and a sulfuric acid compound to recover nickel sulfate,
the sulfation reaction may be performed under conditions characterized by:
a molar ratio of nickel hydroxide to the sulfuric acid compound, expressed as a molar ratio of SO₄/Ni, ranging from 0.5 to 5;
a reaction temperature ranging from 80° C. to 800° C.; and
a reaction time ranging from 0.5 hour to 36 hours.

Here, when the molar ratio of nickel hydroxide to the sulfur-containing compound, expressed as the SO₄/Ni molar ratio, deviates from the specified range, the nickel recovery rate may decrease, or the sulfation reaction efficiency may be reduced.

In this case, the molar ratio of nickel hydroxide to the sulfur-containing compound, expressed as the SO₄/Ni molar ratio, may be preferably in the range of 0.52 to 4.98, and more preferably in the range of 0.55 to 4.95.

In addition, when the reaction temperature deviates from the specified range, the nickel recovery rate may decrease, or the sulfation reaction efficiency may be reduced.

In this case, the reaction temperature may be preferably in the range of 82° C. to 780° C., and more preferably in the range of 85° C. to 750° C.

Furthermore, when the reaction time deviates from the specified range, the nickel recovery rate may decrease, or the sulfation reaction efficiency may be reduced.

In this case, the reaction time may be preferably in the range of 0.5 hours to 24 hours, and more preferably in the range of 3 hours to 12 hours.

FIG. 1 is a process flow diagram of the method for recovering nickel hydroxide and nickel sulfate from nickel-containing material according to an exemplary embodiment of the present disclosure.

Referring back to FIG. 1, the separated nickel hydroxide may be washed (190) to recover the nickel hydroxide (200).

Subsequently, the recovered nickel hydroxide may undergo a sulfation reaction (250) with a sulfur-containing compound to recover nickel sulfate (300).

Nickel Hydroxide Recovered by the Method for Recovering Nickel Hydroxide from Nickel-Containing Material

The present disclosure provides nickel hydroxide recovered by a method in which a nickel-containing material is crushed and pulverized, leached with sulfuric acid, the leached residue and filtrate are separated, and then the pH is adjusted to recover nickel hydroxide.

The present disclosure provides nickel hydroxide recovered by the method for recovering nickel hydroxide from nickel-containing material.

As the present disclosure provides nickel hydroxide recovered by a method in which a nickel-containing material is crushed and pulverized, leached with sulfuric acid, the leached residue and filtrate are separated, and then the pH is adjusted to recover nickel hydroxide, the recovered nickel hydroxide has high purity and a high recovery rate.

Here, the purity of the nickel hydroxide recovered by the method for recovering nickel hydroxide from nickel-containing material may range from 95 to 99.995 wt %.

In addition, the recovery rate of the nickel hydroxide recovered by the method for recovering nickel hydroxide from nickel-containing material may range from 80 to 99.9 wt %.

Nickel Sulfate Recovered from the Method for Recovering Nickel Sulfate from Nickel-Containing Material

The present disclosure provides nickel sulfate recovered by a method in which the recovered nickel hydroxide undergoes a sulfation reaction to recover nickel sulfate.

The present disclosure provides nickel sulfate recovered by the method for recovering nickel sulfate from nickel-containing material.

As the present disclosure provides nickel sulfate recovered by a method in which the recovered nickel hydroxide undergoes a sulfation reaction to recover nickel sulfate, the recovered nickel sulfate has high purity and a high recovery rate.

Here, the purity of the nickel sulfate recovered by the method for recovering nickel sulfate from nickel-containing material may range from 95 to 99.995 wt %.

In addition, the recovery rate of the nickel sulfate recovered by the method for recovering nickel sulfate from a nickel-containing material may range from 80 to 99.9 wt %.

Hereinafter, the present disclosure will be described in more detail through exemplary embodiments. However, the following exemplary embodiments are provided merely to further illustrate the present disclosure, and the scope of the present disclosure is not limited to these exemplary embodiments. The following exemplary embodiments may be appropriately modified or altered by those skilled in the art within the scope of the present disclosure.

### EXEMPLARY EMBODIMENTS

### <Exemplary Embodiment 1> Crushing and Characterization/Content Analysis of MLCC Process Sludge

The multilayer ceramic capacitor (MLCC) process sludge appears in the form of a cake. The sludge generated during the titration/neutralization treatment of MLCC cleaning solution is separated and dried using a filter press before being discharged.

FIG. 2 is a photograph of MLCC process sludge and its pulverized powder according to exemplary embodiment 1 of the present disclosure as described above.

For the evaluation of the leaching characteristics of MLCC process sludge, the sludge was crushed and classified to a particle size of approximately 2 mm or less, as shown in FIG. 2.

Table 1 below presents the particle size distribution of the powder recovered after crushing the MLCC process sludge. The pin mill method was applied for the crushing process.

TABLE 1

| | Particle Size | | | | | |
|---|---|---|---|---|---|---|
| | | 1~2 | 750 | 500~750 | 250~500 | 100~250 |
| | >2 mm | mm | μm~1 mm | μm | μm | μm |
| Content | 5.6 | 16.8 | 70.9 | 3.1 | 2.5 | 1.1 |
| (wt %) | | | | | | |

Table 2 below presents the component composition of the MLCC process sludge. The nickel (Ni) content was found to be approximately 19.26 wt %. In addition, the sludge was confirmed to contain major components such as Al, Fe, Mg, Si, and Ti.

TABLE 2

| | Component | | | | | | | |
|---|---|---|---|---|---|---|---|---|
| | Ni | Al | Fe | Mg | Si | Ba | Ca | P |
| Content (wt %) | 19.26 | 4.65 | 1.75 | 0.9 | 0.82 | 0.48 | 0.47 | 0.47 |
| | Component | | | | | | | |
| | Cu | Zn | Zr | B | Na | Cr | Sr | Mn |
| Content (wt %) | 0.23 | 0.13 | 0.12 | 0.1 | 0.06 | 0.02 | 0.02 | 0.02 |

### <Exemplary Embodiment 2> Leaching Characteristics of MLCC Process Sludge Powder

For the evaluation of the leaching characteristics of MLCC process sludge powder, the sludge was classified to a particle size of 2 mm or less, and leaching experiments were conducted under conditions where the solid-to-liquid ratio (powder (g)/sulfuric acid solution (L)) was 100.

The sulfuric acid solution had a molar concentration ranging from 0.5 to 2 M, and the leaching temperature was maintained within the range of 20 to 80° C.

A reflux reactor equipped with a condenser was used to prevent evaporation during the leaching reaction. In addition, a mechanical stirrer was used to agitate the solution at 300 RPM, and the leaching reaction was carried out for 8 hours.

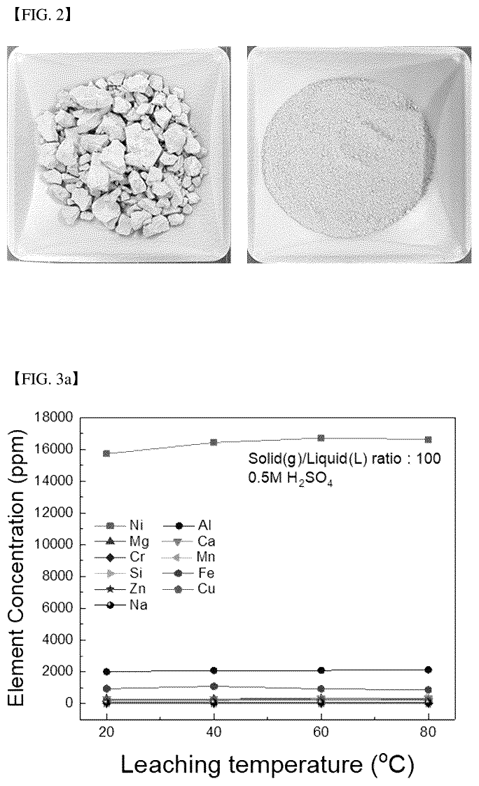

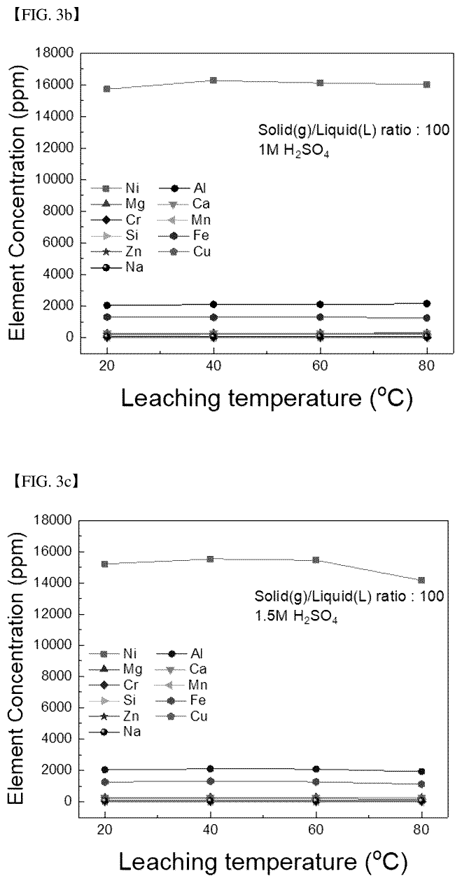

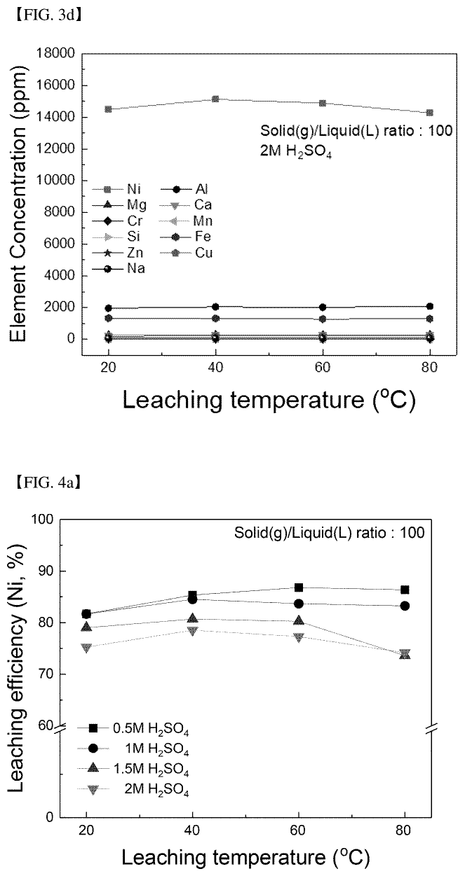

FIGS. 3a to 3d are graphs showing the distribution of leaching concentrations for different components based on sulfuric acid concentration and leaching temperature according to exemplary embodiment 2 of the present disclosure as described above.

Referring to FIGS. 3a to 3d, it was observed that the leaching rate of nickel, the target recovery material, slightly increased with increasing leaching temperature. However, when the sulfuric acid concentration increases up to 1.5 M or more, the leaching rate decreased despite the increase in temperature.

This phenomenon is presumed to be due to the occurrence of a reverse reaction as the concentration of products (sulfur oxides) increases during the leaching reaction of components contained in the MLCC process sludge. Thus, it is considered that using a 0.5 M sulfuric acid solution would be the most appropriate condition, as it can reduce the amount of alkali reagent required in subsequent purification reactions.

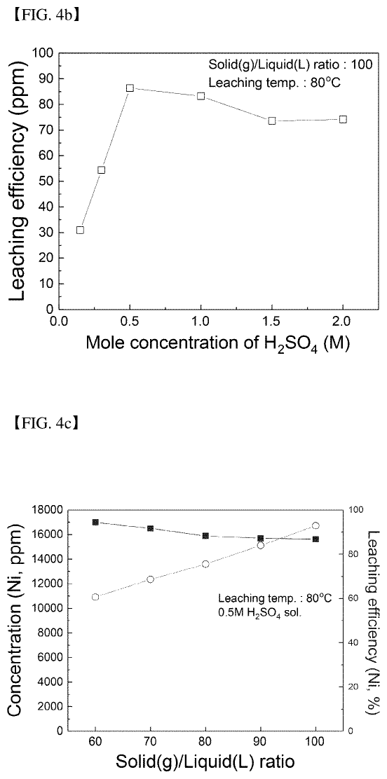

FIGS. 4a to 4c are graphs showing (a) MLCC leaching temperature, (b) sulfuric acid concentration (mol/L) in the leaching solution, and (c) nickel leaching rate based on the solid (g)/liquid (L) ratio according to an exemplary embodiment of the present disclosure.

Referring to FIG. 4a, when leaching was performed at 60° C. using 0.5 M sulfuric acid solution, the highest nickel leaching rate of approximately 87% was observed based on the nickel content in the MLCC process sludge.

Referring to FIG. 4b, when the concentration of sulfuric acid solution was 0.5 M or lower, the nickel leaching rate decreased to 55 wt % or lower.

In addition, referring to FIG. 4c, the leaching rate can be improved to 90 wt % or higher by adjusting the solid-to-liquid ratio to 100 or lower. However, the leachate concentration also decreased, making the subsequent process less economically viable.

### <Exemplary Embodiment 3> Impurity Separation Technology from Sulfuric Acid Leachate

A pH titration method was applied to separate impurities from the leachate obtained after leaching MLCC process sludge under conditions of 0.5 M sulfuric acid solution and a solid (g)/liquid (L) ratio of 100. The impurity separation behavior at different solution pH levels was analyzed using NaOH and Ca(OH)₂.

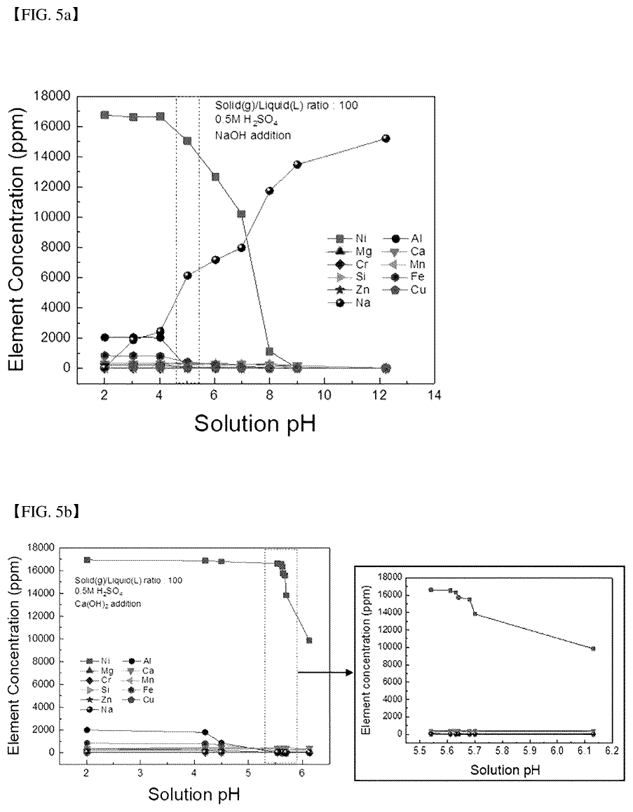

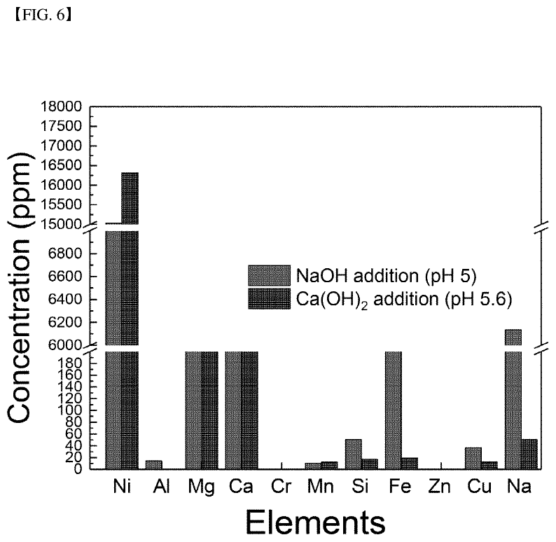

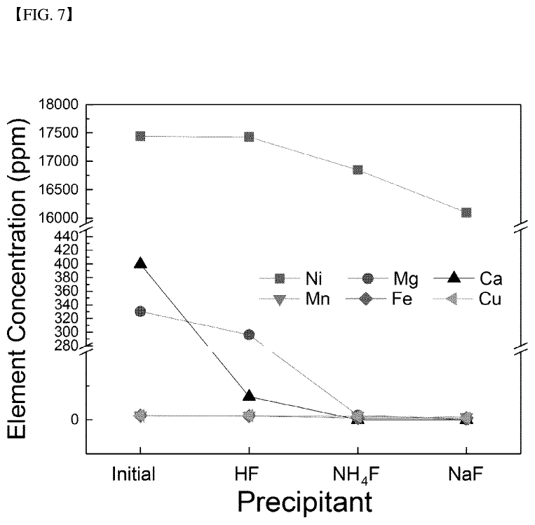

FIG. 5 is a graph showing the distribution of metal ion concentrations in the leaching solution at different pH levels upon the addition of (a) NaOH and (b) Ca(OH)₂ according to exemplary embodiment 3 of the present disclosure as described above.

FIG. 5a shows the residual metal ion concentrations at different solution pH levels when NaOH was added to the leachate.

Referring to FIG. 5a, when the solution pH increased to 5 or higher, not only impurities but also nickel began to precipitate, leading to nickel loss. At pH 8 or higher, it was observed that a nickel loss rate increased to approximately 93% or more.

FIG. 5b shows the residual metal ion concentrations at different solution pH levels when Ca(OH)₂ was added to the leachate.

Referring to FIG. 5b, as the solution pH increased to approximately 5.6, over 95% of impurity components such as Si, Fe, Cu, Zn, and Cr were separated as impurity precipitates, while Mg, Ca, and monovalent ions remained in the solution.

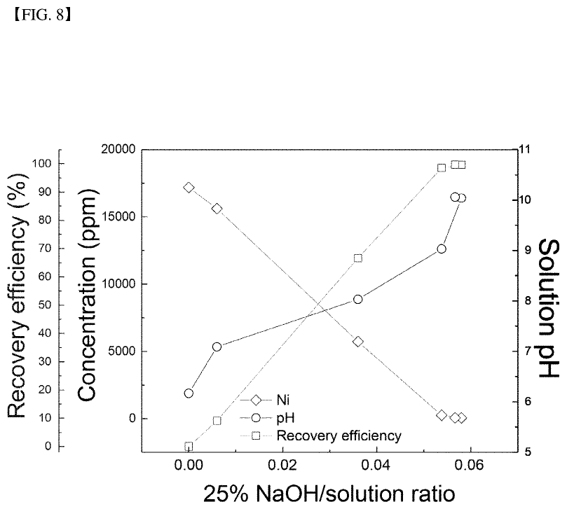

FIG. 6 is a graph showing the distribution of residual ions in the MLCC process sludge leaching solution after applying NaOH and Ca(OH)₂ according to exemplary embodiment 3 of the present disclosure as described above.

FIG. 6 presents the ion concentrations remaining in the leachate under conditions where NaOH and Ca(OH)₂ were applied to separate impurities from the MLCC process sludge leachate, under the condition where the solution pH ranges from 5 to 5.6.

As observed in FIG. 5, the impurity separation efficiency improved with increasing solution pH, but nickel loss also occurred. To prevent this, impurity separation was targeted within the pH range of 5 to 5.6.

Experimental results indicated that using Ca(OH)₂ for the titration reaction effectively suppressed nickel loss, and its impurity separation efficiency was higher compared to NaOH.

In addition, when impurities were separated from the MLCC leachate using NaOH and Ca(OH)₂, the removal efficiency for Mg and Ca was observed to be low. To address this, the MLCC process sludge leachate was first treated with Ca(OH)₂ to precipitate and separate impurities, and the remaining Ca and Mg were converted into fluoride compounds (CaF₂, MgF₂) for removal.

FIG. 7 is a graph showing the distribution of residual ions in the filtrate of MLCC process sludge leachate after applying according to exemplary embodiment 3 of the present disclosure as described above.

Referring to FIG. 7, after leaching MLCC process sludge under the conditions of 5M sulfuric acid solution and a solid (g)/liquid (L) ratio of 100, Ca(OH)₂ was added under a solid (g)/liquid (L) ratio of approximately 15 to remove impurity ions. The formed sludge was then separated, and the remaining primary impurity ions were analyzed. Mg and Ca ions were found to be present at approximately 330 ppm and 399 ppm, respectively, while Fe and Mn ions were detected at approximately 11 ppm and 12 ppm, respectively.

To further remove Mg and Ca ions from the first purified solution, a method of converting them into fluoride precipitates (CaF₂, MgF₂) was considered. The reaction was carried out with an F/(Ca, Mg) molar ratio of 4.

FIG. 7 presents the concentrations of residual components in the filtrate after reacting the first purified solution with fluoride compounds.

For the case of HF, the removal ratios of (Mg, Ca) were observed as (10%, 82%).

For the case of NH₄F, the removal ratios of (Mg, Ca) were observed as (96%, 100%).

For the case of NaF, the removal ratios of (Mg, Ca) were observed as (100%, 100%).

The nickel loss rate in the filtrate after purification was approximately 7%, which was attributed to the increase in solution pH to about 6.5 due to NaF addition, leading to the precipitation reaction of nickel hydroxide.

To suppress nickel loss during the impurity purification process of MLCC leachate, Ca(OH)₂ was first reacted with the leachate under a solid (g)/liquid (L) ratio of approximately 15 to precipitate and separate impurities. Then, 0.3 M sulfuric acid was added to the filtrate after separation to adjust the pH to approximately 3, followed by the addition of NaF under an F/(Ca, Mg) molar ratio of 4.

Experimental results confirmed that when pH adjustment was performed before NaF addition, Ca and Mg ions were completely removed (by 100%), and the nickel loss rate was reduced to 5% or lower.

Monovalent ions such as K and Na, which remained in the filtrate, were expected to be easily removed in the subsequent process through washing after nickel hydroxide precipitation/separation.

### <Exemplary Embodiment 4> Precipitation and Separation of Nickel Hydroxide from Nickel Purification Solution

To separate impurities from the MLCC sludge leachate, Ca(OH)₂ and NaF were sequentially reacted, and the resulting sludge was separated. The nickel component remaining in the filtrate was then precipitated and separated as nickel hydroxide using a 25% NaOH (caustic soda) solution.

FIG. 8 is a graph showing the distribution of nickel content in the filtrate and the recovery rate of nickel hydroxide based on solution pH after applying NaOH according to exemplary embodiment 4 of the present disclosure as described above.

FIG. 8 shows the concentration distribution of residual Ni ions in the purified solution when caustic soda (NaOH) solution was added at different volume ratios (NaOH addition amount/purified solution). It was confirmed that when the solution pH increased to 9 or higher, the Ni component recovery efficiency reached approximately 98% or higher.

To remove water-soluble impurities contained in the nickel hydroxide precipitated and separated from 150 mL of purified solution, the nickel hydroxide was washed with 2 L of purified water. After washing, the recovered nickel hydroxide was then dried in an oven at approximately 60° C., followed by impurity analysis.

As shown in Table 3, the analysis results confirmed that the impurity content was approximately 0.5% or lower (metal basis).

TABLE 3

| | Component | | | | | | | |
|---|---|---|---|---|---|---|---|---|
| | Al | Ca | Co | Cu | Fe | Mn | Si | Zn |
| Content (%) | 0.026 | 0.009 | 0.011 | 0.048 | 0.053 | 0.032 | 0.106 | 0.017 |

In addition, during the impurity purification and nickel hydroxide separation process from the MLCC leachate, the nickel recovery efficiency was determined to be approximately 94 wt %.

### <Exemplary Embodiment 5> Conversion of Nickel Hydroxide to Nickel Sulfate

To produce nickel sulfate, a sulfation roasting reaction was applied to the high-purity nickel hydroxide recovered from the MLCC sludge. The nickel hydroxide and sulfuric acid solution were mixed while adjusting the SO₄/Ni molar ratio within the range of 1 to 2. The sulfation roasting reaction was then carried out at 200 to 1000° C. for 1 hour.

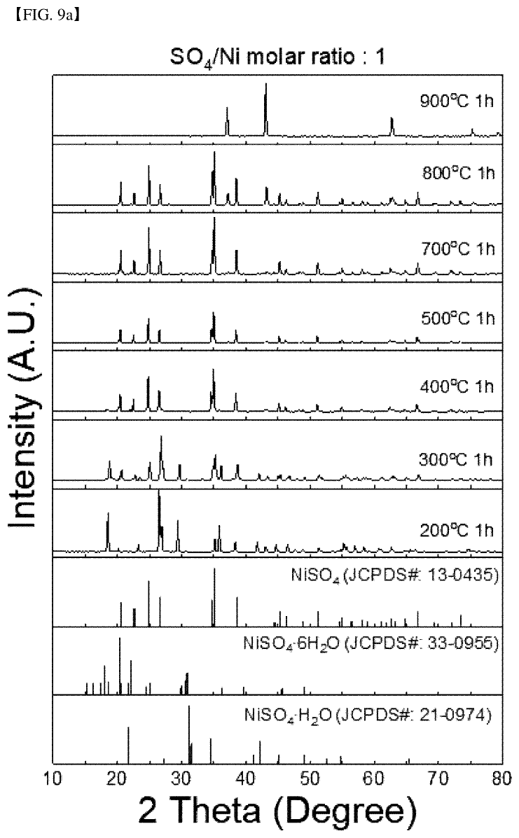

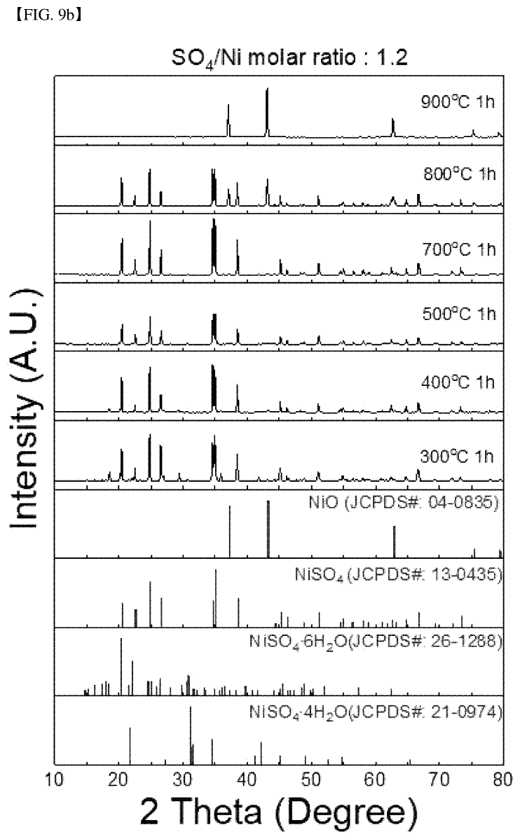

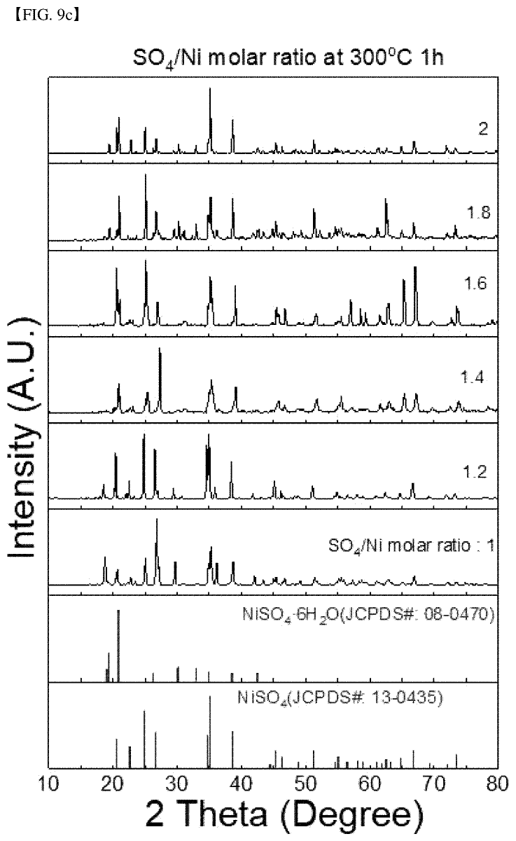

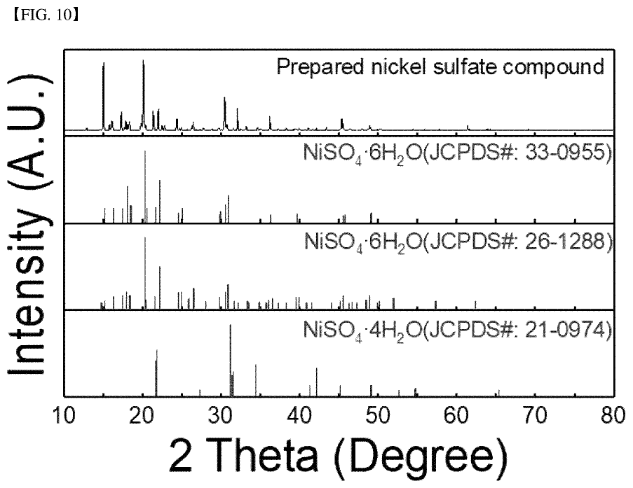

FIGS. 9a to 9c are X-ray distraction (XRD) patterns of nickel sulfate products obtained from the sulfation roasting reaction of nickel hydroxide at different roasting temperatures and SO₄/Ni molar ratios according to exemplary embodiment 5 of the present disclosure as described above.

FIGS. 9a to 9c present the XRD patterns of products synthesized at different roasting temperatures under an SO₄/Ni molar ratio of 1 or 1.2, and the XRD patterns of nickel sulfate products synthesized at a roasting temperature of 300° C. under different SO₄/Ni molar ratios.

Under conditions where the SO₄/Ni molar ratio was 1 or 1.2 at different sulfation roasting temperatures, the nickel sulfate conversion reaction resulted in a mixture of nickel sulfate and nickel sulfate hydrates at roasting temperatures of 300° C. or lower. At 400˜700° C., the main component was identified as nickel sulfate (JCPDS #: 13-0435).

However, when the roasting temperature increased to 800° C. or higher, nickel hydroxide was converted into NiO due to nickel sulfate decomposition reaction. At a roasting temperature of 300° C., the main component was nickel sulfate under SO₄/Ni molar ratios ranging from 1 to 2, but it was observed that nickel sulfate hydrates are mixed.

FIG. 10 shows X-ray distraction (XRD) patterns of nickel sulfate products obtained through the sulfuric acid leaching and crystallization of nickel hydroxide according to exemplary embodiment 5 of the present disclosure as described above.

FIG. 10 presents the XRD patterns of nickel sulfate produced by dissolving nickel hydroxide powder in 1 M sulfuric acid solution, followed by crystallization.

Referring to FIG. 10, the leaching process was conducted under conditions where the solid (g)/liquid (L) ratio of nickel hydroxide (g) to 1 M sulfuric acid solution (L) was approximately 100, at 80° C. for 8 hours. The resulting solution was then crystallized at 80° C. using a rotary evaporator, converting the nickel hydroxide into nickel sulfate.

During the leaching reaction, it was observed that leaching rate became comparatively low at temperatures 60° C. or lower. While increasing the sulfuric acid concentration and lowering the solid-to-liquid ratio could improve leaching efficiency, it also led to a decrease in nickel sulfate content due to the presence of residual sulfuric acid solution after crystallization.

Based on the XRD analysis of the product obtained after leaching and crystallization under the condition of SO₄/Ni molar ratio of approximately 1.1, the main component was identified as NiSO₄·6H₂O.

In the above, exemplary embodiments of the polymer structure through ultrasonic spraying and a manufacturing method therefor according to the present disclosure have been described. Moreover, it will be appreciated that various modifications to these exemplary embodiments are possible without departing from the scope of the present disclosure.

The scope of the present disclosure should therefore not be limited to those exemplary embodiments described above, but should be defined by the following claims and their equivalents.

In other words, the foregoing exemplary embodiments are to be understood as illustrative rather than restrictive in all respects, and the scope of the present disclosure is indicated by the following claims rather than the detailed description. All modifications or variations derived from the meaning, scope, and equivalent concepts of the claims should be interpreted as being included within the scope of the present disclosure.

### INDUSTRIAL APPLICABILITY

The present disclosure can be applied to a method for recovering nickel hydroxide and nickel sulfate from nickel-containing materials generated during the manufacturing process of lithium-ion batteries or the recycling process after use of lithium-ion batteries.

1. A method for recovering nickel hydroxide from nickel-containing material, comprising steps of:
(a-1) crushing and pulverizing a multilayer ceramic capacitor process sludge;
(a-2) leaching the crushed and pulverized multilayer ceramic capacitor process sludge with sulfuric acid to form a first sulfuric acid leachate containing a primary filtrate;
(a-3) separating a leached residue and the primary filtrate from the first sulfuric acid leachate;
(a-4) performing a primary pH adjustment on the first sulfuric acid leachate, from which the leached residue has been separated, to form a second sulfuric acid leachate containing a primary pH-adjusted impurity precipitate and a secondary filtrate;
(a-5) separating the primary pH-adjusted impurity precipitate and the secondary filtrate from the second sulfuric acid leachate;
(a-6) performing a secondary pH adjustment on the second sulfuric acid leachate, from which the impurity precipitate has been separated, to separate nickel hydroxide; and
(a-7) washing the separated nickel hydroxide to recover nickel hydroxide, wherein in the step (a-2) of leaching the crushed and pulverized multilayer ceramic capacitor process sludge with sulfuric acid to form a first sulfuric acid leachate containing a primary filtrate,
a leaching temperature ranges from 10 to 90° C.

2. The method of claim 1,
wherein in the step (a-1) of crushing and pulverizing a multilayer ceramic capacitor process sludge,
the nickel-containing material includes nickel-containing sludge, nickel-containing slag, nickel-containing minerals, or waste ferronickel slag, which are generated during manufacturing of electrical/electronic devices and recycling process of waste electrical/electronic devices, and
wherein a metallic component of the nickel-containing material includes at least one selected from a group consisting of Ni, Al, Fe, Mg, Si, Ba, Ca, P, Cu, Zn, Zr, B, Ba, Cr, Sr, and Mn.

3. The method of claim 1,
wherein in the step (a-1) of crushing and pulverizing a multilayer ceramic capacitor process sludge, the crushing and pulverizing process comprises:
a primary crushing step using a jaw crusher or a cone crusher; and
a secondary pulverizing step using a rod mill, a pin mill, a ball mill, a tube mill, a pot mill, a roller mill, a turbo mill, or a tower mill,
wherein a particle size of the crushed and pulverized multilayer ceramic capacitor process sludge ranges from 0.1 μm to 5 mm.

4. The method of claim 1,
wherein in the step (a-2) of leaching the crushed and pulverized multilayer ceramic capacitor process sludge with sulfuric acid to form a first sulfuric acid leachate containing a primary filtrate,
the sulfuric acid leaching is performed under conditions where a solid-to-liquid ratio of the crushed and pulverized nickel-containing material (g) to sulfuric acid solution (L) ranges from 50 to 200, and
a molar concentration of the sulfuric acid solution ranges from 0.2 to 5 M.

5. The method of claim 1,
wherein in the step (a-3) of separating a leached residue and the primary filtrate from the first sulfuric acid leachate,
separation of impurity from the first sulfuric acid leachate is performed by separating the leached residue that has not leached.

6. The method of claim 1,
wherein in the step (a-4) of performing a primary pH adjustment on the first sulfuric acid leachate, from which the leached residue has been separated, to form a second sulfuric acid leachate containing a primary pH-adjusted impurity precipitate and a secondary filtrate,
a pH of the primary pH adjustment ranges from 2 to 7.

7. The method of claim 1,
wherein in the step (a-5) of separating the primary pH-adjusted impurity precipitate and the secondary filtrate from the second sulfuric acid leachate, the separation of the impurity precipitate from the second sulfuric acid leachate is performed by a pH titration method sequentially using metal hydroxide and metal fluoride,
wherein the metal hydroxide is at least one selected from a group consisting of NaOH, KOH, Mg(OH)₂, Ca(OH)₂, and Al(OH)₃, and
wherein the metal fluoride is at least one selected from a group consisting of sodium fluoride (NaF), ammonium fluoride (NH₄F), potassium fluoride (KF), ferrous fluoride (FeF₂), ferric fluoride (FeF₃), aluminum fluoride (AlF₃), and hydrofluoric acid (HF).

8. The method of claim 1,
wherein in the step (a-5) of separating the primary pH-adjusted impurity precipitate and the secondary filtrate from the second sulfuric acid leachate, the separation of the impurity precipitate from the second sulfuric acid leachate is performed by a pH titration method sequentially using metal hydroxide and metal fluoride,
wherein conditions for the separation of the impurity precipitate include:
a pH titration temperature ranging from 10 to 90° C.;
a molar ratio of nickel to metal hydroxide in the second sulfuric acid leachate ranging from 1:0.01 to 0.01:1; and
a molar ratio of nickel to metal fluoride in the second sulfuric acid leachate, after nickel and impurities in the second sulfuric acid leachate have been pH-titrated and separated as metal hydroxides, ranging from 1:0.02 to 0.02:1.

9. The method of claim 1,
wherein in the step (a-6) of performing a secondary pH adjustment on the second sulfuric acid leachate, from which the impurity precipitate has been separated, to separate nickel hydroxide,
a pH of the secondary pH adjustment ranges from 6 to 13.

10. The method of claim 1,
wherein in the step (a-7) of washing the separated nickel hydroxide to recover nickel hydroxide,
the washing is performed using deionized water to remove water-soluble impurity components contained in the nickel hydroxide.

11. A method for recovering nickel sulfate from nickel-containing material, comprising steps of:
(a-1) crushing and pulverizing a multilayer ceramic capacitor process sludge;
(a-2) leaching the crushed and pulverized multilayer ceramic capacitor process sludge with sulfuric acid to form a first sulfuric acid leachate containing a primary filtrate;
(a-3) separating a leached residue and the primary filtrate from the first sulfuric acid leachate;
(a-4) performing a primary pH adjustment on the first sulfuric acid leachate, from which the leached residue has been separated, to form a second sulfuric acid leachate containing a primary pH-adjusted impurity precipitate and a secondary filtrate;
(a-5) separating the primary pH-adjusted impurity precipitate and the secondary filtrate from the second sulfuric acid leachate;
(a-6) performing a secondary pH adjustment on the second sulfuric acid leachate, from which the impurity precipitate has been separated, to separate nickel hydroxide;
(a-7) washing the separated nickel hydroxide to recover nickel hydroxide; and
(a-8) performing a sulfation reaction between the recovered nickel hydroxide and a sulfuric acid compound to recover nickel sulfate,
wherein in the step (a-2) of leaching the crushed and pulverized multilayer ceramic capacitor process sludge with sulfuric acid to form a first sulfuric acid leachate containing a primary filtrate,
a leaching temperature ranges from 10 to 90° C.

12. The method of claim 11,
wherein in the step (a-8) of performing a sulfation reaction between the recovered nickel hydroxide and a sulfuric acid compound to recover nickel sulfate,
the sulfuric acid compound is at least one selected from a group consisting of: sulfuric acid (H₂SO₄), sulfurous acid (H₂SO₃), hyposulfurous acid (H₂SO₂), magnesium sulfate (MgSO₄), magnesium sulfite (MgSO₃), magnesium hyposulfite (MgSO₂), calcium sulfate (CaSO₄), calcium sulfite (CaSO₃), calcium hyposulfite (CaSO₂), ferrous sulfate (FeSO₄), ferrous sulfite (FeSO₃), ferrous hyposulfite (FeSO₂), ferric sulfate (Fe₂(SO₄)₃), ferric sulfite (Fe₂(SO₃)₃), ferric hyposulfite (Fe₂(SO₂)₃), ammonium sulfate ((NH₄)₂SO₄), aluminum sulfate (Al₂(SO₄)₃), aluminum sulfite (Al₂(SO₃)₃), and aluminum hyposulfite (Al₂(SO₂)₃).

13. The method of claim 11,
wherein in the step (a-8) of performing a sulfation reaction between the recovered nickel hydroxide and a sulfuric acid compound to recover nickel sulfate,
the sulfation reaction is performed under conditions characterized by:
a molar ratio of nickel hydroxide to the sulfuric acid compound, expressed as a molar ratio of SO₄/Ni, ranging from 0.5 to 5;
a reaction temperature ranging from 80° C. to 800° C.; and
a reaction time ranging from 0.5 hour to 36 hours.

14. A nickel hydroxide recovered by the method for recovering nickel hydroxide from nickel-containing material according to claim 1.

15. A nickel sulfate recovered from the method for recovering nickel sulfate from nickel-containing material according to claim 11.
